(19) United States
(12) Patent Application Publication
(10) Pub. No.: US 2010/0309535 A1
(43) Pub. Date: Dec. 9, 2010

(54) Shutter-glass eyewear control

(75) Inventors: Roger Landowski, Erie, CO (US); Greg Graham, Boulder, CO (US); Robert R. Rotzoll, Cascade, CO (US); Douglas J. Gorny, Boulder, CO (US)

Correspondence Address: REALD Inc. - Patent Department, by Baker & McKenzie LLP, 2001 Ross Avenue, Suite 2300, Dallas, TX, 75201, US

(73) Assignee: RealD INC., Beverly Hills, CA (US)

(21) Appl. No.: 12/796,494

(22) Filed: Jun. 8, 2010

Related U.S. Application Data
(60) Provisional application No. 61/185,095, filed on Jun. 8, 2009.

(51) Int. Cl. G02B 27/22; G06E 1/02

(52) U.S. Cl. 359/107; 359/464

(57) ABSTRACT

A method for shutter glass eyewear control provides for a command sequence having precise shutter timing and control information for opening and closing the left and right shutters of shutter glass eyewear. The infrared signal commands are offset from the corresponding shutter action to minimize interference while still allowing the eyewear to track changes in the timing of the infrared signal received from a display system. Command sequence encodings are provided for enhanced interference rejection.

### CROSS REFERENCE TO RELATED APPLICATIONS

This patent application relates to provisional patent application Ser. No. 61/185,095, entitled “Shutter-Glass Eyewear Control,” to Landowski et al. which was filed Jun. 8, 2009, which is herein incorporated by reference for all purposes.

### BACKGROUND

1. Technical Field

This disclosure generally relates to shutter glasses and, more specifically, relates to a schema for shutter glass eyewear control.

2. Background

Shuttering eyewear (or shutter glasses) can be used to enable stereoscopic 3D and to provide different images to two viewers using a single display, which is known as dual view. These devices utilize an infrared (IR) signal generated by an infrared emitter which is compliant with Video Electronics Standard Association (VESA) Standard Connector and Signal Standards for Stereoscopic Display Hardware, Version 1, Nov. 5, 1997 (“VESA Standards”), which are herein incorporated by reference. As described in the VESA Standards, an emitter outputs a very simple pulse width modulated signal to indicate which eye to activate.

The eyewear responds by performing a hard-coded sequence of switching events which open and close the eyewear shutters in order to achieve the desired visual effect. The hard-coded switching sequence is generally either a compromising solution which provides acceptable performance for a set of displays or an optimized solution which is optimized (hard-coded) for a single display.

Due to the use of low cost assembly techniques, dense circuitry, high surge current used to switch the shutters, and low power design techniques, shuttering eyewear creates an electrically noisy environment in which the processing logic operates. When used with the pulse width modulation technique, the switching point for the shutters is typically at or very near the transition point of the infrared sync signal. This may limit the sensitivity of the infrared detector and, thus, may limit the infrared detector's ability to differentiate between system noise and the infrared signal.

### BRIEF SUMMARY

A method for transmitting an infrared signal of a command sequence to shutter glasses is provided. According to an aspect, a command sequence having shutter timing information is provided. The shutter timing relates to one or more actions including, but not limited to, opening a left shutter of the shutter glasses, closing the left shutter of the shutter glasses, opening a right shutter of the shutter glasses, and closing the right shutter of the shutter glasses. The infrared signal of the command sequence is also emitted.

In some embodiments, the infrared signal of the command sequence is offset from a shutter glasses switching point.

A method for processing an infrared signal of a command sequence is also provided. According to an aspect, an infrared signal of a command in a command sequence is received. The command includes shutter timing information for one or more actions including, but not limited to, opening a left shutter of the shutter glasses, closing the left shutter of the shutter glasses, opening a right shutter of the shutter glasses, and closing the right shutter of the shutter glasses. In accordance with this aspect, the infrared signal of the command is signal processed to determine logic 1's and logic 0's in the command. In some embodiments, the command is used to initialize an action including, but not limited to, one of opening the left shutter of the shutter glasses, closing the left shutter of the shutter glasses, opening the right shutter of the shutter glasses, and closing the right shutter of the shutter glasses.

Other features and aspects are described with reference to the detailed description and appended claims.

### BRIEF DESCRIPTION OF THE DRAWINGS

FIG. 1 is a schematic diagram of a shutter glass eyewear system, in accordance with the present disclosure;

FIG. 2 is a schematic diagram of an encoder and infrared emitter, in accordance with the present disclosure;

FIG. 3 is a schematic diagram of a decoder and controller, in accordance with the present disclosure;

FIG. 4 is a table of exemplary command encodings, in accordance with the present disclosure;

FIG. 5 is a schematic diagram of bit detection, illustrating the reception of an incoming infrared bit stream and processing thereof, in accordance with the present disclosure;

FIG. 6 is a timing diagram illustrating exemplary switching waveforms for a 3D mode operating scenario, in accordance with the present disclosure;

FIGS. 7 and 19 are timing diagrams illustrating exemplary switching waveforms for a Dual View mode operating scenario, in accordance with the present disclosure;

FIG. 8 is a timing diagram illustrating exemplary switching waveforms for a 2D mode operating scenario, in accordance with the present disclosure;

FIG. 9 is a schematic diagram illustrating an embodiment of an infrared command transmission, in accordance with the present disclosure;

FIG. 10 is a table of a set of exemplary command encodings, in accordance with the present disclosure;

FIG. 11 is a table of another set of exemplary command encodings, in accordance with the present disclosure;

FIG. 12 is a flow diagram illustrating detection of exemplary command encodings, in accordance with the present disclosure;

FIG. 13 is a schematic diagram illustrating a swap or toggle stereo (3D) viewing embodiment of a command structure and logical timing scheme, in accordance with the present disclosure;

FIG. 14 is a schematic diagram illustrating a stereo or 3D viewing embodiment of a command structure and logical timing scheme, in accordance with the present disclosure;

FIG. 15 is a schematic diagram illustrating a mono or 2D viewing embodiment of a command structure and logical timing scheme, in accordance with the present disclosure;

FIG. 16 is a schematic diagram illustrating a dual view embodiment of a command structure and logical timing scheme, in accordance with the present disclosure;

FIG. 17 is a schematic diagram illustrating another dual view embodiment of a command structure and logical timing scheme, in accordance with the present disclosure; and

FIG. 18 is a chart of an embodiment of the coarse timing of exemplary commands, in accordance with the present disclosure.

### DETAILED DESCRIPTION

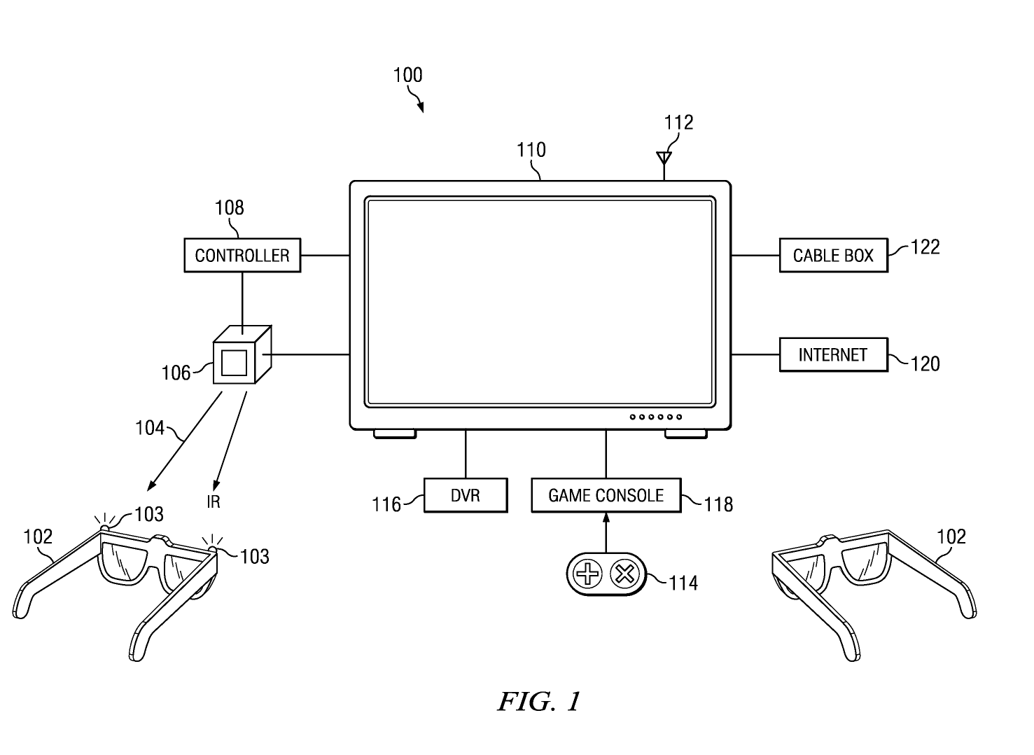

FIG. 1 is a schematic diagram of a shutter glass eyewear system 100. The shutter glass system 100 may include a display 110 viewed by one or more viewers wearing shutter glasses 102. The shutter glasses 102 may have an infrared receiver 103 for receiving infrared signals 104 from an infrared emitter 106. The infrared emitter 106 may be connected to a controller 108 connected to the display 110. For example, 3D-ready televisions may have a jack for connecting to an emitter 106. In addition, the infrared emitter 106 and controller 108 may be contained in the same casing (not shown). The display 110 itself may contain the controller 108 and infrared emitter 106 in the display 110 casing (not shown). The display 110 may be connected to other video or streaming content devices including, but not limited to, a game console 118, cable or satellite box 122, internet-connected device 120, antenna 112, and DVR player 116. Internet-connected device 120 may provide streaming video media, downloaded media, websites, internet applications, and the like. A viewer wearing shutter glasses 102 may operate a game controller 114 associated with the gaming console 118.

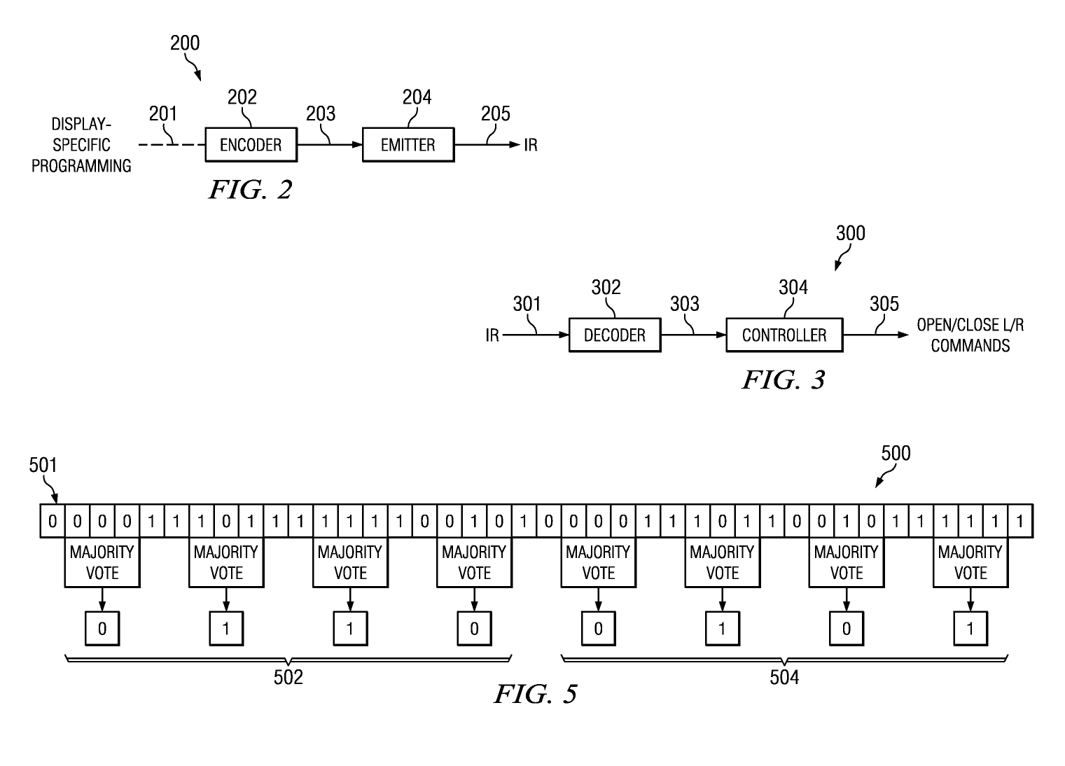

FIG. 2 is a schematic diagram of apparatus 200 having an encoder 202 and emitter 204 configuration for a shutter glass eyewear system. The encoder 202 and emitter 204 are associated with a display in the shutter glass eyewear system (as shown in FIG. 1). The encoder 202 may consider display specific programming when encoding a control sequence 203. The encoder 202 encodes a control sequence 203, providing instructions for opening and closing left and right shutters of shutter glass eyewear; and the emitter 204 emits an infrared signal 205 of the control sequence 203. FIG. 2 shows the encoder 202 and emitter 204 as separate boxes, but one skilled in the art would understand that the encoder 202 and emitter 204 may be included in a single device. Also, elements of the encoder 202 and emitter 204 may comprise hardware, software, or a mixture of both. In some embodiments, the encoder 202 and emitter 204 may be part of (or encased within) a display while in other embodiments, the encoder 202 and emitter 204 may be a separate device for use with a display.

FIG. 3 is a schematic diagram of apparatus 300 including a decoder 302 and controller 304 configuration for a shutter glass eyewear system. The decoder 302 and controller 304 are associated with the infrared receiver of the shutter glasses in the eyewear system (as shown in FIG. 1). In operation, the decoder 302 decodes an infrared signal of a control sequence and provides the decoded signal 303 to a controller mechanism 304. The controller mechanism 304 provides a command signal 305, instructing the left and right shutters to open or close. FIG. 3 shows the decoder 302 and controller 304 as separate boxes, but one skilled in the art would understand that the decoder 302 and controller 304 may be included in a single device. Also, elements of the decoder 302 and controller 304 may comprise hardware, software, or a mixture of both.

Unidirectional infrared signaling may be used for display devices to transmit synchronization and shutter timing information to control active shutter eyewear. In an embodiment, multiple elements are communicated to the eyewear including, but not limited to, one or more of the following: how to align in time the shutter action with the display action; the sequence of shutter action (i.e., the order to open and close each shutter); the duration each shutter is open or closed; and the mode of operation (e.g., whether the system is operating in “mono” or “stereo” mode). This disclosure relates, in part, to sending open and close shutter commands to accomplish the above described elements of communication. This disclosure also expands on that concept and provides embodiments for enhanced interference rejection.

In some of the disclosed embodiments, a general purpose shutter glasses implementation allows an integrated eyewear design having a decoding mechanism 302 and a controller mechanism 304 to support a wide variety of displays and multiple operating modes (e.g., 2D, 3D, dual view, etc.) and can also transparently accommodate improvements in display technology.

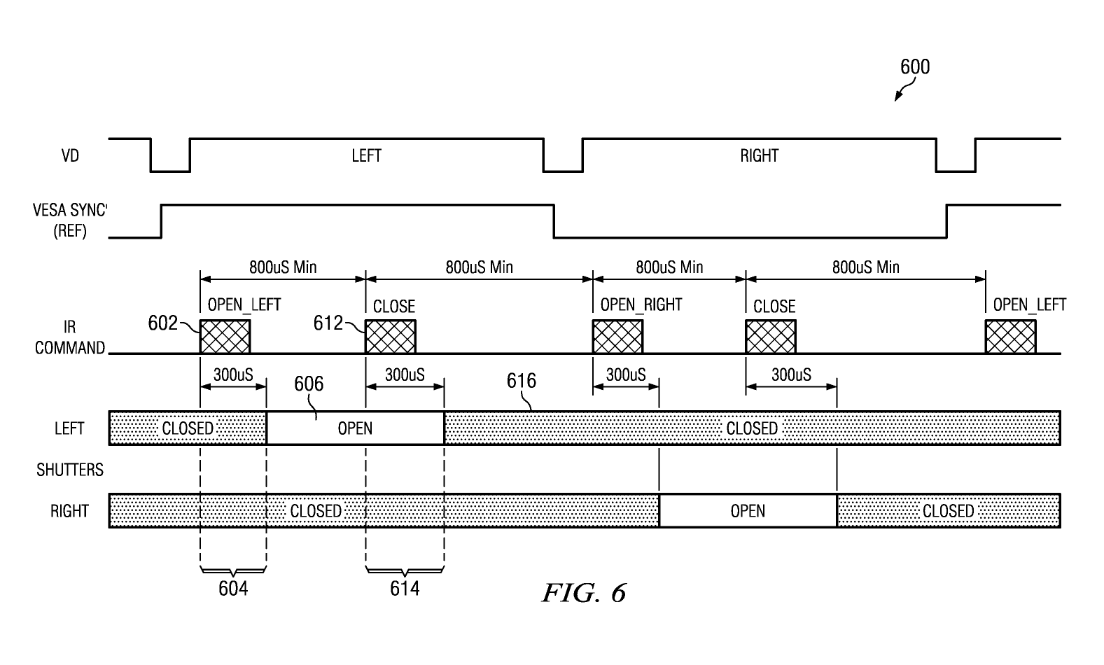

In some of the disclosed embodiments, the infrared signal (e.g., 205 in FIGS. 2 and 301 in FIG. 3) is offset from a shutter glasses switching point by an amount that minimizes interference while still allowing the eyewear to track changes in the timing of the infrared signal received from the display system. This will be discussed in further detail below in relation to FIG. 6.

The present disclosure provides a protocol for controlling the shutter operation of the shutter glasses (e.g., 201, 203, and 205 of FIG. 2; and 301, 303, 305 of FIG. 3). In an embodiment, the protocol is transmitted over an infrared link. The commands may be implemented as a pulse code scheme which may be transferred and decoded at very low cost. This scheme allows for a single eyewear design that may work with displays from multiple vendors.

A display vendor may optimize the duty cycle and switching points of the eyewear based on the characteristics of each display model or technology. Commands are sent indicating which shutter to open or close and when to open or close that shutter. One benefit resulting from this type of control is that it allows for specific and precise segments of content to be viewed. For example, in an embodiment, both lenses are closed during a segment of time in which left image content is on the display. At this time, the left image content may be partially written or may not be at an appropriate level for proper viewing. Once the left image content is ready for viewing, the left shutter is opened. Thus, the shutter is opened during the portion of the left image content cycle in which the left image content is ready for viewing. Another benefit for this type of control is that different types of displays may be used with the eyewear. The variations in display technology may be reflected in the timing of the signals (discussed further below in relation to FIG. 6) generated by the display used for controlling the eyewear. Also, improvements in display technology may be reflected in the timing of the signals generated by the display (discussed further below in relation to FIG. 6), with minimal or substantially no modifications to the eyewear design. And, likewise, improvements in eyewear technology will have minimal impact on the design of the display device.

In addition to the protocol, the present disclosure establishes a set of timing designs to control the time between receiving a command and acting on it and the minimum time between commands. This disclosure also allows for increased sensitivity to the infrared signal which will increase range, reduce power, and lower cost for both the eyewear and display. This disclosure also provides a command encoding and timing scheme to enhance the protocol by enhancing command sequence qualification, which provides better timing and enhances interference rejection.

### Protocol

A pulse code protocol may be utilized to transfer a data packet, which indicates the action that the eyewear is to take.

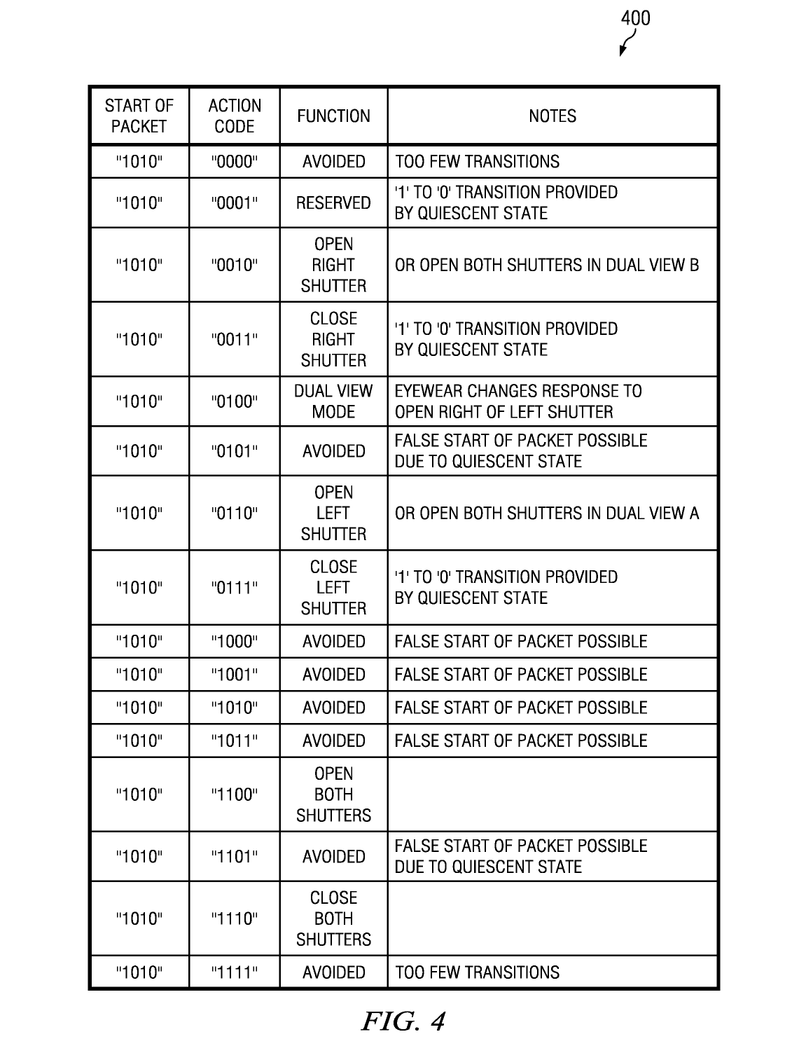

In an embodiment, in operation, the data transfer is performed at a rate of 65536 bits/sec, which is derived from an up-conversion of an inexpensive 32768 Khz watch crystal-based oscillator and selected to avoid operating at popular infrared remote control data rates. The quiescent state between data packets is a logic zero. The start of a packet is indicated by the bit sequence “1010”. The next four bits of the data sequence indicate the action to be performed. To simplify the detection of the data packet header and prevent false header detection in an electrically noisy environment, several of the codes are avoided. In an embodiment, to provide more robust data transfer in an electrically noisy environment, each command may have at least one ‘0’ to ‘1’ and at least one ‘1’ to ‘0’ transition. FIG. 4 is a table 400 of the available “action codes” and codes suitable for utilization. As shown in table 400, codes that are “avoided” are undesirable for utilization in this embodiment of the disclosed schema.

In an embodiment, the differentiation between Dual View modes A and B is made by the eyewear (i.e., a user may manually select which image they wish to view).

### Detection

FIG. 5 is a schematic diagram 500 of bit detection, illustrating the reception of an incoming infrared bit stream and processing thereof. An infrared signal from an emitter associated with a display device is initially detected using conventional techniques to amplify, filter, and level detect the output of the infrared emitter. The amplified, filtered, and level-detected signal 501 is fed into a 40-bit shift register, which operates at five times the bit rate. To find the center of the data bits, the middle three bits of each 5-bit segment of the shift register are processed by majority vote logic, the output of which is passed to an 8-bit holding register. The contents of the holding register are examined to detect the start of packet sequence 504 and a subsequent action code 502. One having skill in the art would understand that the top bit of the shift register is not used. It is shown to clarify how the center of the bit time is found.

When a start of packet 504 is detected, a software or hardware-based processing scheme (or a combination of software and hardware processing scheme) will act on the action code 502 to operate the shutters within the time frame specified for the system.

### Switching

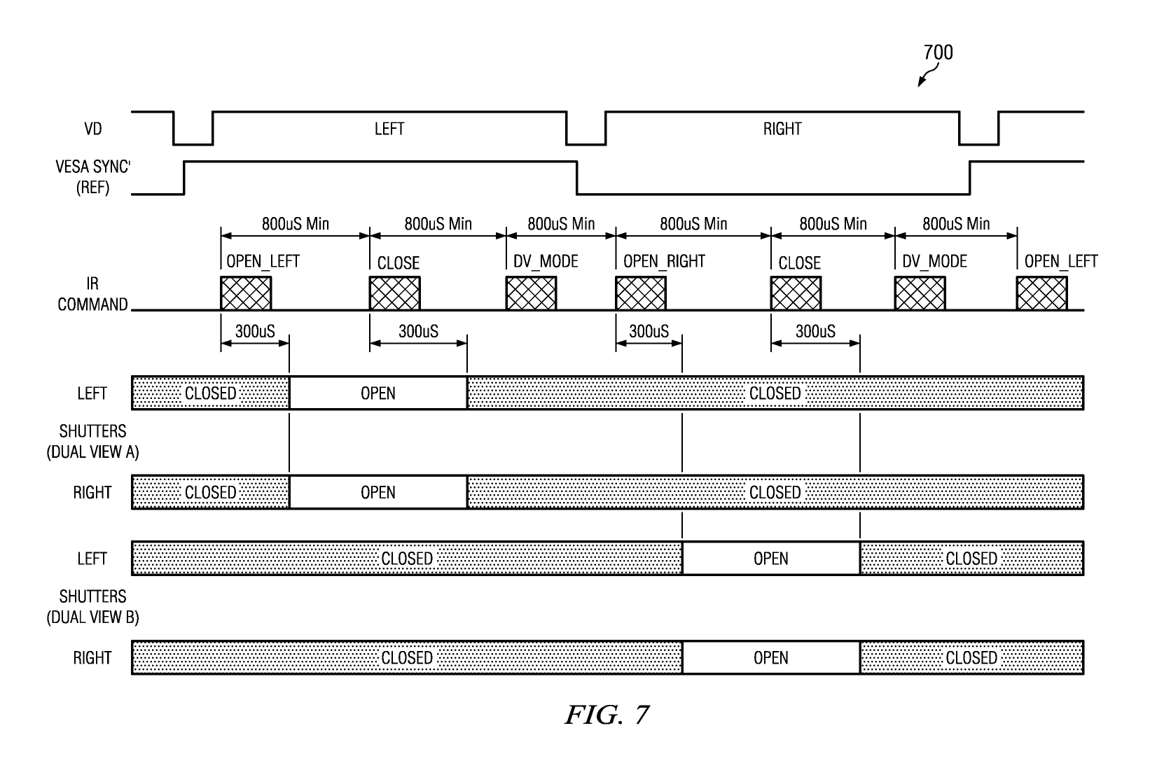

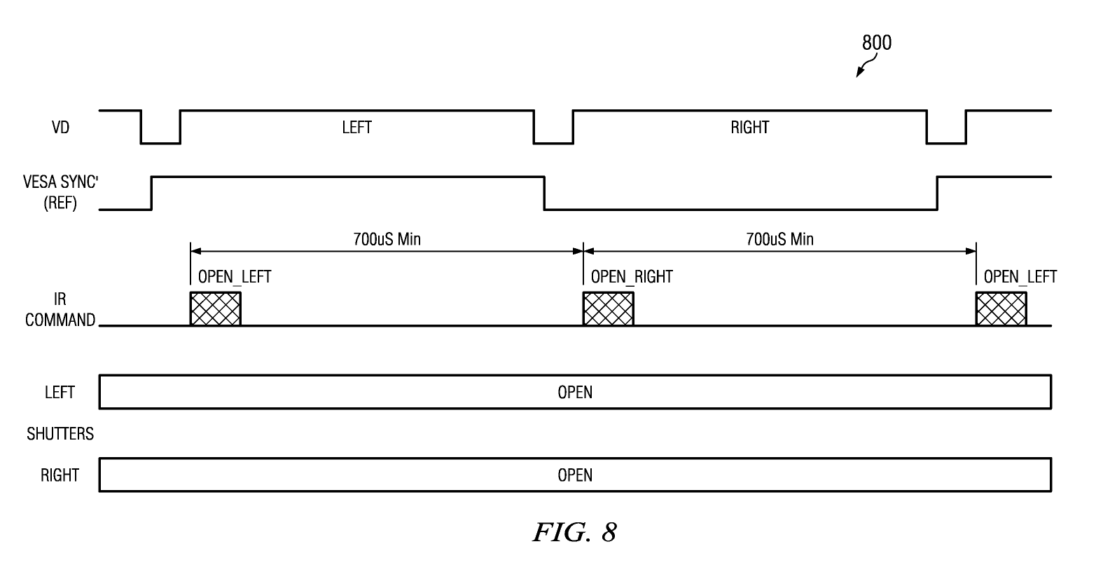

FIGS. 6-8 are schematic diagrams of switching waveforms for various operating scenarios 600, 700, 800. FIG. 6 is a switching waveform for a 3D mode 600. FIG. 7 is a switching waveform for a dual view mode 700. FIG. 8 is a switching waveform for a 2D mode 800. The timings shown are examples only; the actual timing values will be system dependent. For example, FIG. 6 shows a switching waveform that can be adjusted to work with different display technologies. For example, the “left close” command 612 may be shifted to the right, resulting in the left lens staying open for a longer period of time. Or the “left open” command 602 and the “left close” command 612 may both be shifted to the right, resulting in changed timing for the left lens to be open 606. Thus, a display emitter (or an emitter associated with a display) may send when exactly to open and close the left and right shutters with specific commands. The display (or an emitter associated with the display) may control the eyewear and one pair of eyewear may work for any display. A display emitter (or an emitter associated with a display) may be customized to control the eyewear based on the display specifications. The timing parameters for a display having an emitter (or an emitter associated with a display) associated with the left, right, open, and close commands may be adjusted. The timing of the commands may be hard coded into a display as well. The eyewear operates based on these customized commands and timings.

As discussed above in relation to FIGS. 2 and 3, the infrared signal may be offset from a shutter glasses switching point by an amount that minimizes interference while still allowing the eyewear to track changes in the timing of the infrared signal received from the display system. In an embodiment, the switching or shuttering of the lenses occurs at a time other than when an infrared signal is anticipated. When the switching occurs, it may be difficult to detect an infrared signal. By designing a protocol in which the shuttering occurs at a time other than when an infrared signal is anticipated, the communication becomes more robust and the infrared signal becomes easier to detect.

For example, referring back to FIG. 6, the infrared command for the left lens to open 602 is separated by a distance in time 604 from the actual action of the left lens opening 606. Similarly, the infrared command for the left lens to close 612 is separated by a distance in time 614 from the actual action of the left lens closing 616. Similar delays may be seen in FIG. 7. This allows the command to move during operation, accommodating timing skews and system inaccuracies. The time between commands is set to allow power supply and switching noise generated by the shutter operation to settle out before the next command is received. In an embodiment, the delay between the start of a command and its execution is approximately twice the command time.

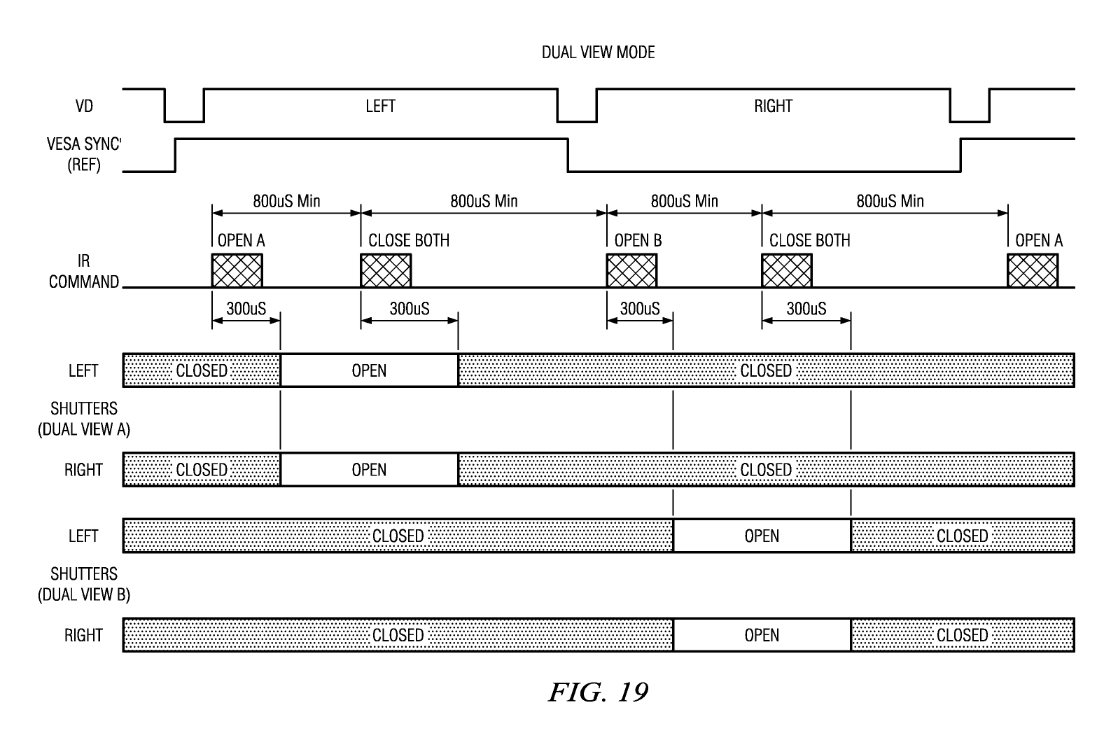

In a dual view embodiment 700, the dual view command does not cause any switching operation and is used to keep the eyewear in this mode. If the dual view command is not detected for several frames the eyewear will default back to 3D mode. In another exemplary dual view embodiment, shown in FIG. 19, the dual view commands indicate when to open the shutters for the A or B channel. The Close Both command is used to close both shutters independent of which channel A or B was told to open.

Note that the “VESA SYNC” signal is shown for reference purposes. If the infrared emitter resides within the display device this signal may not physically exist.

Since changing the frame rate changes the relationship between commands by an amount greater than that accommodated by the timing specifications, the display system should issue either continuous OPEN or CLOSE commands at the new frame rate for several frames. This allows the eyewear to establish synchronization to new timing parameters.

### Enhanced Interference Rejection

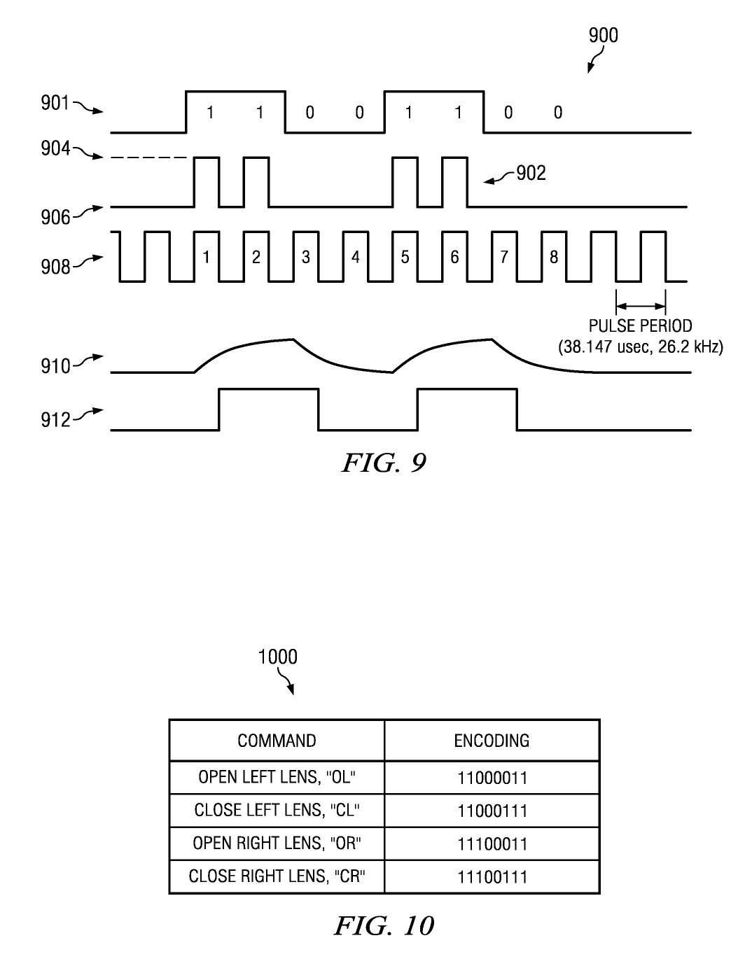

FIG. 9 is a schematic diagram 900 illustrating detailed command encoding for an embodiment providing enhanced interference rejection. The data to be transmitted 901 includes logic 1's and 0's. The data to be transmitted 901 can be translated to an infrared emitter output 902. When the emitter output 902 is a logic 1, the infrared emitter LED is on 904; and when the emitter output 902 is a logic 0, the infrared emitter LED is off 906. The TX reference clock is shown at 908. The signal 910 shows the envelope demodulated signal and the signal 912 is the data sent to the shutter controller.

As discussed above in relation to FIG. 3, unidirectional infrared signaling may be used for display devices to transmit synchronization and shutter timing information to control active shutter eyewear. In controlling active shutter eyewear, the following elements may be communicated:

(1) How to align in time the shutter action with the display action;
(2) The sequence of shutter action (the order to open and close each shutter);
(3) The duration each shutter is open or closed; and
(4) The mode of operation (e.g., mono, stereo, etc.).

Commands may be used to communicate these elements. For an 8-bit command, 256 different combinations of 0's and 1's are possible, with some combinations being more robust for transmission and accurate detection. In an embodiment, eight 8-bit commands are selected to communicate open left, close left, open right, close right, swap left to right, swap right to left, dual view left, and dual view right commands. In an embodiment, for more robust transmission and accurate detection, the eight selected commands are chosen from a list of ten possible 8-bit codes adhering to the following code rules: (1) the command has a minimum of two pulses for two logic one states; and (2) the command has a minimum of two missing pulses for two logic zero states. The ten possible codes (of the 256 different combinations of 0's and 1's for an 8-bit command) are 11000011, 11000110, 11000111, 11001100, 11001110, 11001111, 11100011, 11100110, 11100111, and 11110011. Any eight of these ten possible codes may be used to communicate the open left, close left, open right, close right, swap left to right, swap right to left, dual view left, and dual view right commands.

In another embodiment, six commands are used to specify the open left, close left, open right, close right, swap left to right, and swap right to left commands. Any six of the ten possible codes may be used. In a preferred embodiment, the six codes having a non-zero termination are used: 11000011, 11000111, 11001111, 11100011, 11100111, and 11110011.

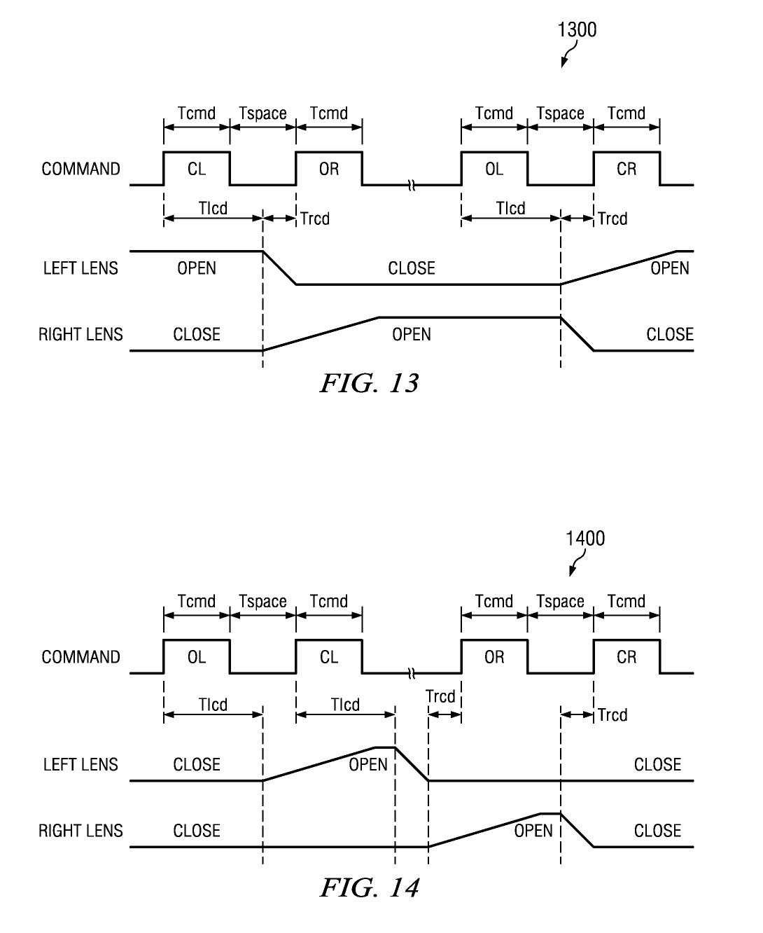

In an embodiment, four commands are used to specify the communication elements discussed above. Using four commands provides for numerous advantages. Using four commands is more straight forward and less confusing than using six, eight, or more commands. These four command encodings may be used to implement all the communication elements discussed above. This technique also allows for fast and flexible switching between 3D, 2D, and dual view modes. In the 3D mode, the left video channel is coordinated with the left shutter while the right video channel is coordinated with the right shutter. In 2D mode, a single video channel is coordinated with both the left and right shutter. In the dual view, either the left or right video channel is coordinated with both lenses (depending on the viewer's selection at the eyewear). “Dual view” and “both” commands may be executed using the four commands without having to have a special command (or commands) for these actions. Swap commands may also be achieved (e.g., put together close left and open right commands to create a swap left to right command, as shown in FIG. 13 below). In an embodiment, a toggle switch is also included on the eyewear for activating a dual view mode. In addition, using all four commands in each cycle allows for enhanced signal detection. If a receiver detects open left, close left, open right, but not a close right command, the receiver knows that the cycle is incomplete. This aids in command sequence validation processes.

FIG. 10 is a table 1000 illustrating one set of four command encodings. For example, the command for opening the left lens (“OL”) is encoded as 11000011; the command for closing the left lens (“CL”) is encoded as 11000111; the command for opening the right lens (“OR”) is encoded as 11100011; and the command for closing the right lens (“CR”) is encoded as 11100111.

Using the encodings of table 1000 results in numerous benefits. Better interference rejection is achieved because a minimum of two pulses for logic one states are used. Better interference rejection is also achieved because a minimum of two missing pulses are used for logic zero states. The resulting command length is eight cycles, or 305 μs, for more flexible command timing. In addition, the code is a fixed length, which also allows for enhanced interference rejection.

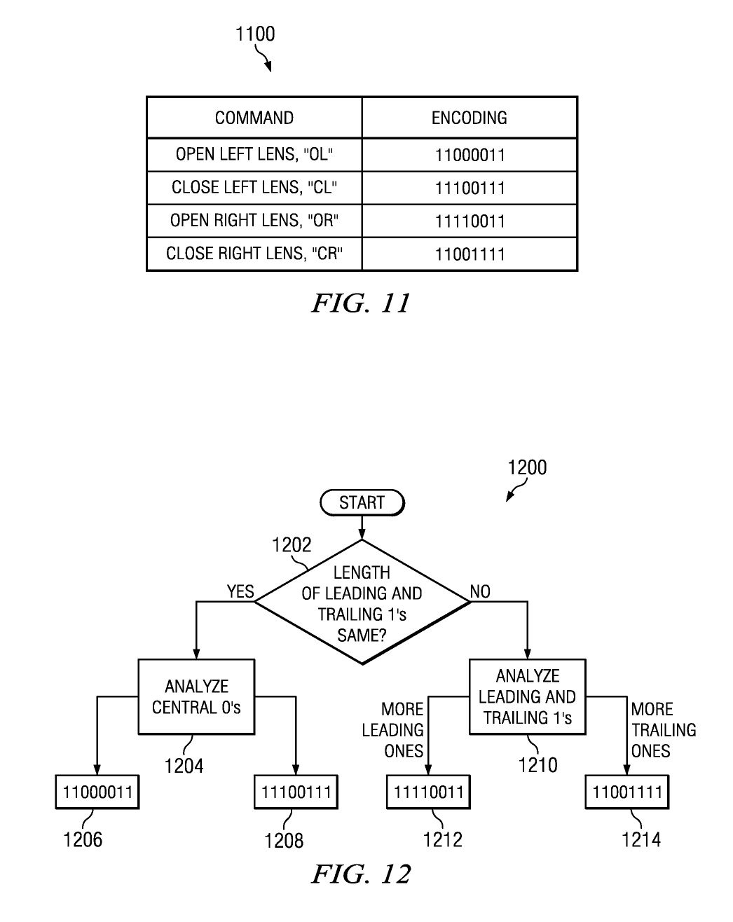

FIG. 11 is a table 1100 illustrating another set of four command encodings. For example, the command for opening the left lens (“OL”) is encoded as 11000011; the command for closing the left lens (“CL”) is encoded as 11100111; the command for opening the right lens (“OR”) is encoded as 11110011; and the command for closing the right lens (“CR”) is encoded as 11001111. This embodiment achieves easier signal detection, as detecting these signals avoids detecting a 1-count difference in the number of 0's or 1's in a row. Using an analog receiver circuit, it is difficult to detect a 1-count difference using conventional techniques.

FIG. 12 is a flow diagram 1200 illustrating detection of the command encodings of FIG. 11. First, the length of the leading and trailing 1's of an encoded command are analyzed to determine whether the length is the same at 1202. If the length of leading and trailing 1's are the same length then the command is either “11000011” or “11100111” and the 0's in the middle of the encoded command are analyzed at block 1204. A two-count difference between the four zeros in the middle of “11000011” and the two zeros in the middle of “11100111” allows for easier distinction between the commands. Thus, if four zeros are detected, then the command is “11000011” (block 1206); and if two zeros are detected, then the command is “11100111” (block 1208). Also, note that the length of the leading and trailing 1's of the other encoded commands (“11110011” and “11001111”) are offset by two counts and, thus, the fact that these commands do not contain the same length of leading and trailing 1's is easier to detect.

If the leading and trailing 1's are not the same length at block 1202, then the leading and trailing 1's are analyzed at block 1210. If the leading 1's count is higher than the trailing 1's count, then the encoded command is “11110011” (block 1212); and if the trailing 1's count is higher than the leading 1's count, then the encoded command is “11001111” (block 1214). Again, note that the length of the leading and trailing 1's of the other encoded commands (“11110011” and “11001111”) are offset by two counts and, thus, determining the count of the leading versus trailing 1's is easier.

### Protocol Command Structure and Timing

As discussed above, four commands may be used to specify communication elements. In an embodiment, the following rules are observed:

A) All four commands are used once during each command sequence;

B) Left shutter action occurs with a positive delay relative to the leading edge of the left commands;

C) Right shutter action occurs with a negative delay relative to the leading edge of the right commands; and

D) Commands are timing accurate.

Numerous benefits may be realized when the preceding rules A-D are followed. One example of a benefit realized using the above mentioned rules is enhanced sequence qualification (e.g., for gathering data to update “Fly Wheel Parameters”). The use of Rule A minimizes ambiguity in the command sequence. In an embodiment, each of the four commands is represented only once in a proper sequence. This qualification makes the overall protocol more robust with respect to interference tolerance. Rules A and D allow any command to be used as the start of a command sequence allowing for phase independent commands. This allows for faster command sequence qualification and for phase independence. In an embodiment, a series of five commands are received for command sequence qualification. This also creates more interference tolerant communication by allowing for command sequence qualification to occur on any received series of five commands. Rule D also provides four timing reference points per command sequence. This allows for more stringent qualification of each command to ensure it is valid when using sequence qualification schemes using two or more complete sequences. This also allows for easier rejection of rogue commands for better interference tolerance.

FIG. 13 is a schematic diagram 1300 illustrating a swap or toggle stereo “3D” viewing embodiment of a command structure and logical timing scheme. Rules B and C allow the command pairs OL/CR and CL/OR to be executed in order such that their corresponding lens action occurs substantially simultaneously, creating the equivalent of swap or toggle commands. As can be seen in FIG. 13, the left shutter lens closes after a positive delay relative to the leading edge of the close left command while the right shutter lens opens with a negative delay relative to the leading edge of the open right command (per Rules B and C).

FIG. 14 is a schematic diagram 1400 illustrating a standard stereo or 3D viewing embodiment of a command structure and logical timing scheme. FIG. 14 illustrates stereo operation with precise duty cycle control. Rules B, C, and D allow the commands to precisely communicate when the shutters are open and closed.

As discussed above, separating the lens action from infrared transmission reduces noise at the receiver allowing for better command reception.

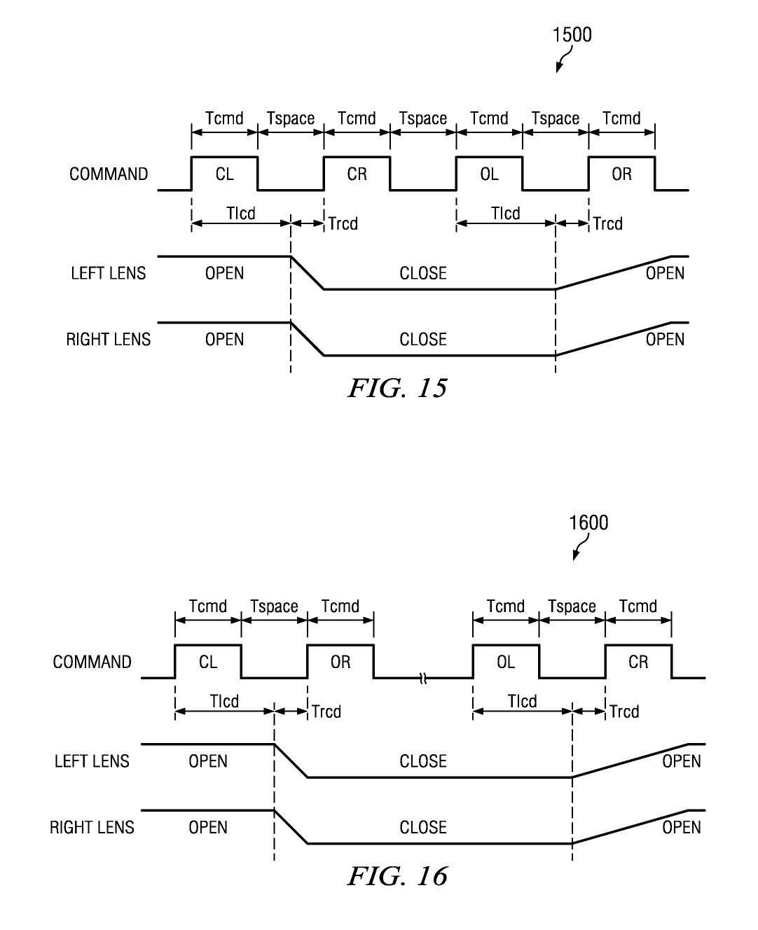

FIG. 15 is a schematic diagram 1500 illustrating a mono or 2D viewing embodiment of a command structure and logical timing scheme. FIG. 15 illustrates mono operation with in phase left/right shutter control. Rules B and C allow the command pairs OL/OR and CL/CR to be executed in order such that their corresponding lens action occurs substantially simultaneously, creating an in-phase shuttering of left and right lenses. In an embodiment, when switching between mono and stereo viewing, the lenses are partially shuttered during mono viewing to minimize or substantially avoid a brightness shift.

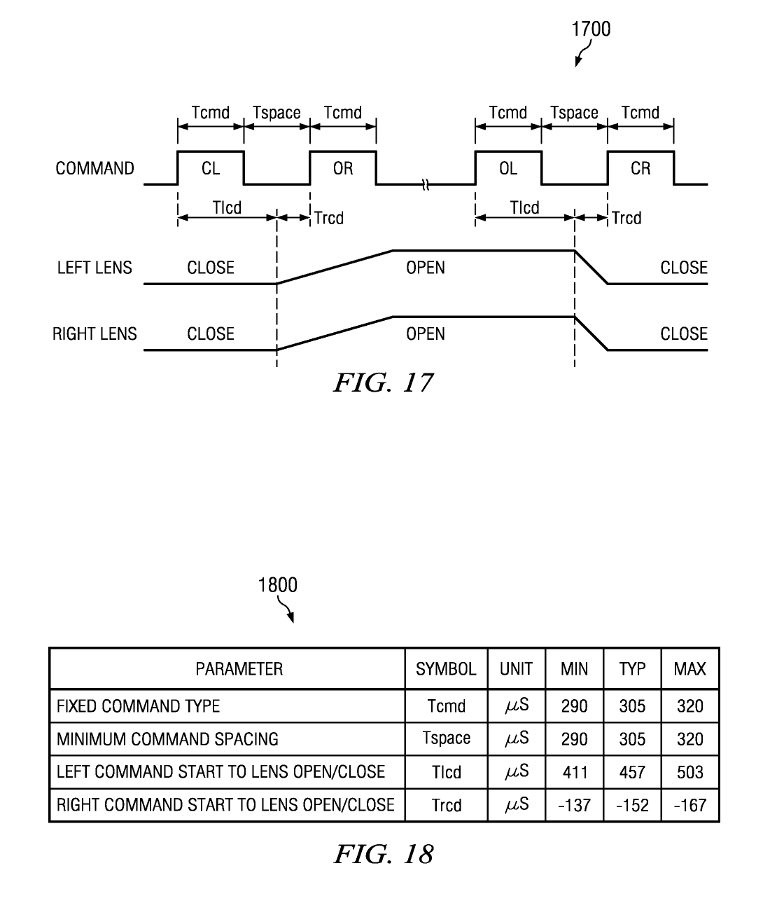

FIGS. 16 and 17 are schematic diagrams illustrating a command and lens timing scheme for “dual view” left lens viewing 1600 and “dual view” right lens viewing 1700.

FIG. 18 is a chart 1800 illustrating an embodiment of the coarse timing of the commands. Based on the exemplary timing shown in chart 1800, the command structure and coarse timing definitions, the following are achieved. The minimum open shutter duration in standard stereo mode is 610 μS. FIG. 14 illustrates this restriction for the Left Lens open and closing action. In an embodiment, the minimum open duration is (Tcmd+Tspace+Tlcd)−Tlcd or Tcmd+Tspace. The minimum close shutter duration between right open and left open in standard stereo mode is 1220 μS. FIG. 14 illustrates this restriction for the Right Lens closing to Left Lens opening action (wrap the timing around from right to left). The minimum closed duration is −Trcd+Tcmd+Tspace+Tlcd. The minimum close shutter duration between left open and right open in standard stereo mode is 0 μS. FIG. 14 illustrates this restriction for the Left Lens closing to Right Lens opening action (removing the wavy lines and make the time between CL and OR exactly one Tspace). The minimum closed duration is (Tcmd+Tspace)−(Tlcd−Trcd). The minimum open or closed shutter duration in standard mono mode is 1220 μS. FIG. 15 illustrates this restriction for the open and closing action on both shutters substantially simultaneously. The minimum closed duration is (Tcmd+Tspace+Tcmd+Tspace+Tlcd)−Tlcd or 2Tcmd+2Tspace. This timing holds true for open and close minimum mono mode durations.

The benefit of having shorter (more flexible) commands may be realized with the preceding case. In an embodiment, the cycle repetition maximum frequency in stereo mode operation with minimum 25% duty cycle restriction is 204 Hz. This is calculated by multiplying the minimum right to left open close shutter close time (1220 μS) by four to get a command sequence time of 4880 μS, which corresponds to 204.92 Hz. The cycle repetition maximum frequency in mono mode operation with minimum 50% duty cycle restriction is 409 Hz. This is calculated by multiplying the minimum open or closed shutter close time (1220 μS) by two to get a command sequence time of 2440 μS, which corresponds to 409.84 Hz.

The enhanced command sequence and timing scheme still allows for the command transmission and shutter action to be separated in time.

While various embodiments in accordance with the disclosed principles have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. A method for transmitting an infrared signal to shutter glasses, the method comprising:
providing a command sequence having shutter timing information for opening a left shutter of the shutter glasses, closing the left shutter of the shutter glasses, opening a right shutter of the shutter glasses, and closing the right shutter of the shutter glasses;
emitting an infrared signal of the command sequence.

2. The method of claim 1, further comprising offsetting the infrared signal of the command sequence from a shutter glasses switching point.

3. The method of claim 2, wherein offsetting the infrared signal further comprises separating by a distance in time a command of the command sequence and an action associated with the command.

4. The method of claim 3, wherein the distance in time is approximately twice a second distance in time, the second distance in time associated with a pulse length for the command.

5. The method of claim 1, wherein providing the command sequence further comprises the command sequence indicating which of the left shutter and the right shutter to open or close and when to open or close that shutter.

6. The method of claim 1, wherein providing the command sequence further comprises the command sequence having instructions for relating timing of a display action with timing of at least one of opening the left shutter of the shutter glasses, closing the left shutter of the shutter glasses, opening the right shutter of the shutter glasses, and closing the right shutter of the shutter glasses.

7. The method of claim 1, wherein providing the command sequence further comprising the command sequence having shutter action sequence information.

8. The method of claim 1, wherein providing the command sequence further comprises the command sequence having shutter action duration information.

9. The method of claim 1, wherein providing the command sequence further comprises the command sequence having shutter glasses mode information.

10. The method of claim 1, further comprising optimizing at least one of a duty cycle, switching points, and signal timing of the command sequence based on characteristics of a display.

11. The method of claim 1, further comprising establishing timing designs of the command sequence, the timing designs for determining a delay period between when the shutter glasses receive a command of the command sequence and when the shutter glasses act on the command.

12. The method of claim 1, wherein providing the command sequence further comprises the command sequence having shutter timing information for one of a swap sequence, a dual mode, or a both mode.

13. The method of claim 1, wherein providing the command sequence further comprises each command in the command sequence having eight pulses representing eight bits, and wherein a minimum of two consecutive pulses of the eight pulses represent logic one states, and wherein a minimum of two other consecutive pulses of the eight pulses represent logic zero states.

14. The method of claim 13, wherein providing the command sequence further comprises each command in the command sequence having a minimum of two pulses different from another commend in the command sequence.

15. The method of claim 14, wherein a cycle of the command sequence comprises four commands, and wherein the four commands comprise 11000011, 11100111, 11110011, and 11001111.

16. A method for processing an infrared signal of a command sequence, the method comprising:
receiving an infrared signal of a command of the command sequence, the command having shutter timing information for one of opening a left shutter of the shutter glasses, closing the left shutter of the shutter glasses, opening a right shutter of the shutter glasses, and closing the right shutter of the shutter glasses;
signal processing the infrared signal of the command to determine logic 1's and logic 0's in the command;
using the command to initialize an action including one of opening the left shutter of the shutter glasses, closing the left shutter of the shutter glasses, opening the right shutter of the shutter glasses, and closing the right shutter of the shutter glasses.

17. The method of claim 16, wherein the signal processing comprises one or more of amplifying the infrared signal, filtering the infrared signal, and level detecting the infrared signal.

18. The method of claim 16, wherein using the command further comprises performing the action associated with the command after a distance in time passes from receiving the infrared signal of the command.

19. The method of claim 18, wherein the distance in time is approximately twice a second distance in time, the second distance in time associated with a pulse length for the command.

20. The method of claim 16, wherein using the command further comprises determining from the command sequence which of the left shutter and the right shutter to open or close and when to open or close that shutter.

21. The method of claim 16, wherein using the command further comprises relating timing of a display action with timing of at least one of opening the left shutter of the shutter glasses, closing the left shutter of the shutter glasses, opening the right shutter of the shutter glasses, and closing the right shutter of the shutter glasses.

22. A method of claim 16, wherein signal processing the infrared signal results in a command having leading and trailing logic 1's, and wherein using the command further comprises:
analyzing leading and trailing logic 1's in the command to determine a first length corresponding to a number of leading logic 1's and a second length corresponding to a number of trailing logic 1's;
determining whether the first and second lengths are the same;
if the first and second lengths are the same, analyzing central 0's in the command to determine a number of central 0's; and
if the first and second lengths are different, determining which of the first length or the second length is longer.
